(19) United States
(12) Patent Application Publication
(10) Pub. No.: US 2013/0052425 A1
(43) Pub. Date: Feb. 28, 2013

(54) MICRO-NANO COMPOSITE STRUCTURE AND PRODUCTION METHOD THEREOF

(71) Applicants: Hung-Yin TSAI, Hsinchu City (TW); Cheng-Kuo Sung, Hsinchu City (TW); Cheng-Huan Chen, Hsinchu City (TW); Ching-Wen Liu, Hsinchu City (TW)

(72) Inventors: Hung-Yin TSAI, Hsinchu City (TW); Cheng-Kuo Sung, Hsinchu City (TW); Cheng-Huan Chen, Hsinchu City (TW); Ching-Wen Liu, Hsinchu City (TW)

(21) Appl. No.: 13/296,502

(22) Filed: Nov. 15, 2011

(30) Foreign Application Priority Data
Aug. 25, 2011 (TW) 100130436

(51) Int. Cl. B32B 3/30; B29C 59/02; C25D 7/00

(52) U.S. Cl. 428/172; 205/50; 264/241

(57) ABSTRACT

A micro-nano composite structure and production method thereof, whereby a micro structure is fabricated by a first layer material, and then a second layer material (such as: aluminum) covers the micro structure which conducts current through the second layer material forming an anodized aluminum to produce a nanostructure, and this nanostructure is layered on the micro structure. This structure, when completed, can be used as a mold, moreover by using nano-imprinting technology this structure can be transferred onto a transparent polymer material in a one-time production process to produce one micro-nano composite structure, and achieving a reduction of the reflection coefficients and an increased transmittance, as well as raising the usage rate of the integrated light.

### BACKGROUND OF THE INVENTION

1. Field of the Invention

This invention relates to a kind of micro-nano composite structure, in particular to a nanostructure layered on a micro structure, moreover it can be produced in a one-time production process, and at the same time this structure can achieve a reduction of the reflection coefficients and increase the transmittance.

2. Description of Related Art

The object of optical diffusion film is that the diffused incident light widens the angular scope. Currently many LCD optical industry systems, including LED, BLM and LCD monitors etc. and their applications, all require an optical diffusion film for the point light source or the linear light source to be transferred and become a surface light source, so as to keep their uniformity and timely achieve the best display effect. But traditional optical films are made from a metal substrate to produce a single structure (as in a nanostructure or micro structure) and the reflection coefficients of the optics and the transmittance are already lower, and thus the usage rate of the integrated light is reduced. For a long time the industry has been criticized for these shortcomings, therefore how to improve the usage rate of the light of a micro-nano structure composite has become the focus of research for the industry.

Therefore to layer and manufacture a nanostructure on a micro structure, with no way of using traditional ultra-precision machining processes or optical photolithography for production, and because of the difficulty in layering a nanostructure on a micro structure in the production process, there is the possibility of failure in the layering process. Even if in the layering process the nanostructure is successfully layered on the micro structure to produce an optical film, when this optical film having a micro-nano structure proceeds with optical simulation, rigorous coupled wave theory must be used, or finite-difference time-domain method must be used to proceed with simulation analysis. Because of the included micro structure, when doing simulated analysis the time will be increased, and if the simulated time is overly long it will result in the experiment process being lengthy, and the statistics and results from the experiment won't necessarily meet the requirements. When the statistics and results from the experiment don't meet requirements, another simulation is needed which requires huge increases in manpower and time.

Therefore the applicant has aimed his technical knowledge and learning at these drawbacks, and is combining optical diffusion film structure and an anti-reflective subwavelength structure, to complete the micro-nano structure in a one-time production process, thus allowing for uniform distribution of the light, and also achieving reduced reflection coefficients as well as increased transmittance and increased usage rate of light. This invention “micro-nano composite structure and production method thereof” is therefore used to improve on the conventional means and its drawbacks.

### SUMMARY OF THE INVENTION

The object of this invention is to provide a kind of micro-nano composite structure and a production method thereof, whereby a micro structure is constructed by one first layer material, then one second layer material covers this micro structure, and a current is passed through this second layer material to form anodized alumina, thus producing a nanostructure. This nanostructure is layered on the micro structure, and nano imprinting technology is used to transfer this structure onto a transparent polymer structure, thus forming a polymer element to achieve the goal of increased reflection coefficients and increased penetration levels.

To achieve the above-mentioned goal, this invention's technological measures are: one first layer material is produced to become a micro structure and one second layer material is layered on this micro structure as the nanostructure, and this micro-nano composite structure can be manufactured in a one-time production process.

The micro-nano composite structure of the invention combining a micro structured diffusion film and a nanostructure with anti-reflective characteristics has the following described advantages:

1. The structured diffusion film utilizes light diffraction properties to evenly distribute the light. Because of this, the efficiency rate of the light is greatly increased.

2. The structured diffusion film doesn't cause the light to be unevenly distributed

3. The nanostructure has anti-reflective characteristics to lower the reflection rate, to achieve the goal of resisting reflection.

4. The wavelength of the light and penetration angle of the light in the subwavelength structure is less restricted than traditional multi-layered anti-reflective film. Traditional multi-layered anti-reflective film has the effect of reducing resistance to reflection.

5. Incorporates a large area of the nano-imprinting processes, high production value and other characteristics.

This invention improves upon the traditional ultra-precision machinery process and optical lithography, incorporating an anodized aluminum process to achieve reduced costs, large areas and high added value to meet trends and requirements. This invention when completed can also be a mold, moreover nano-imprinting technology can be used to transfer this structure onto transparent polymer material, The penetration rates of this structure is clearly higher than non-nano structures, which will have great value on the market.

The invention, as well as its many advantages, may be further understood by the following detailed description and drawings in which:

### BRIEF DESCRIPTION OF THE DRAWINGS

FIG. 1 is a schematic diagram showing micro-nano composite structure of the present invention.

FIG. 2 is a data chart showing a diffusion film without nanostructure simulated by computer.

FIG. 3 is a data chart showing a diffusion film with nanostructure simulated by computer.

FIG. 4 is a production flow chart showing a micro-nano composite structure of the present invention.

FIG. 5 is the schematic diagram showing the production method of the silicon molds of the present invention.

FIG. 6 is the perspective diagram showing the silicon mold of the present invention.

FIG. 7 is the structure diagram showing an anodized aluminum layer formed on a silicon substrate of the present invention.

FIG. 8 is the schematic diagram showing a micro-nano composite structure of the present invention.

FIG. 9 is a schematic diagram showing that the present invention converts the micro-nano structure onto a transparent polymer by using nano-imprint lithography.

FIG. 10 is the perspective diagram showing the polymer structure of the present invention after nano-imprinting.

FIG. 11 is the transmittance diagram showing each angle of each sample of the present invention.

FIG. 12 is a diagram of the results showing the transmittance increment of each sample of the present invention.

### DETAILED DESCRIPTION OF THE INVENTION

The technical characteristics and operation processes of the present invention will become apparent with the detailed description of preferred embodiments and the illustration of related drawings as follows.

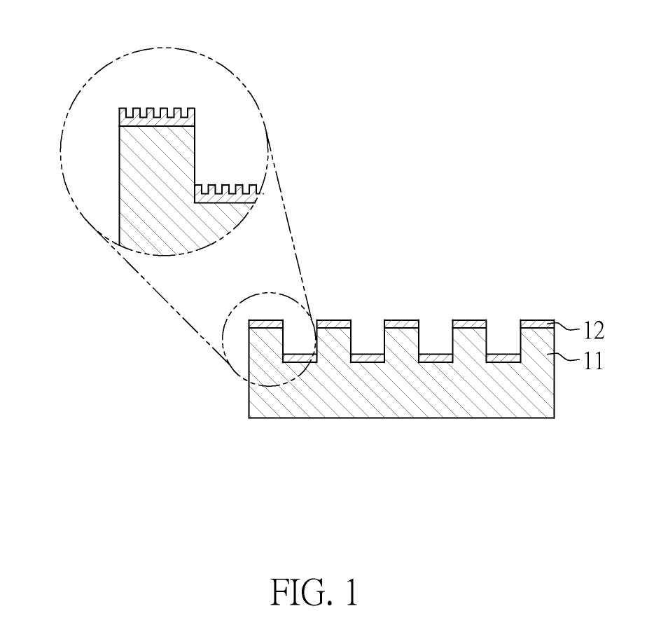

With reference to FIG. 1, the micro-nano composite structure of the present invention is composed of a micron structure 11 and a nanostructure 12.

The micro structure 11 is produced by a first layer material, and the first layer material is one selected from the group consisting of: silicon, germanium, glass and semiconductors etc., and then the nanostructure 12 is layered on the micro structure 11 so as to produce the composite structure.

In one embodiment, the nanostructure 12 is a second layer material coated on the micro structure 11 (the covering technology in this embodiment is not limited to the use of the coating technology, but all the techniques of covering the nano-material on the micro material are available), the second layer material is selected from a metal (such as: aluminum or other metals materials), and a current is passed through the metal for anodizing so as to produce a nanostructure with an anodized aluminum.

First of all, the photolithography technology is used to produce the silicon substrate, thereby forming the micro structure 11, which can be accomplished and replaced by using precision machining, laser machining, electroforming technology, and are not limited to these techniques listed in this embodiment. The production process of the micro structure 11 won't be repeated again here for it's a conventional photolithography technology.

When the micro structure 11 is formed, a second layer material covers (such as: aluminum, other metal materials are also available) the micro structure 11, and then a current is passed through the second layer material for anodizing so as to produce the nanostructure with an anodized aluminum, thereby coating the nanostructure 12 on the micro structure to produce the micro-nano composite structure.

In one embodiment, a composite diffusion film with the micro structure 11 and the nanostructure 12, and a diffusion film with only micro structure 11, respectively use rigorous coupled-wave theory (RCWT) for computer simulation experiments of transmittance and reflection coefficient, and the duty cycle of the micro structure 11 is set at 10 microns (w), and the duty cycle of the nanostructure is set at 100 nanometers (nm), and the result data obtained is as in the following table 1:

list 1

| | with nanostructure | | | without nanostructure | | |
|---|---|---|---|---|---|---|
| wavelength | reflection | | | reflection | | |
| (nm) | coefficient | transmittance | total | coefficient | transmittance | total |
| 380 | 0.011697551 | 0.988302449 | 1 | 0.046741349 | 0.953258651 | 1 |
| 390 | 0.011697551 | 0.988302449 | 1 | 0.033361049 | 0.966638951 | 1 |
| 400 | 0.011697551 | 0.988302449 | 1 | 0.037660721 | 0.962339279 | 1 |
| 410 | 0.011697551 | 0.988302449 | 1 | 0.056636025 | 0.943363975 | 1 |
| 420 | 0.011697551 | 0.988302449 | 1 | 0.097085322 | 0.902914678 | 1 |
| 430 | 0.011697551 | 0.988302449 | 1 | 0.05410357 | 0.94589643 | 1 |
| 440 | 0.011697551 | 0.988302449 | 1 | 0.029135003 | 0.970864997 | 1 |
| 450 | 0.011697551 | 0.988302449 | 1 | 0.020344392 | 0.979655608 | 1 |
| 460 | 0.011697551 | 0.988302449 | 1 | 0.033668698 | 0.966331302 | 1 |
| 470 | 0.011697551 | 0.988302449 | 1 | 0.050270402 | 0.949729598 | 1 |
| 480 | 0.011697551 | 0.988302449 | 1 | 0.059252912 | 0.940747088 | 1 |
| 490 | 0.011697551 | 0.988302449 | 1 | 0.057112999 | 0.942887001 | 1 |
| 500 | 0.011697551 | 0.988302449 | 1 | 0.039483918 | 0.960516082 | 1 |
| 510 | 0.011697551 | 0.988302449 | 1 | 0.026392892 | 0.973607108 | 1 |
| 520 | 0.011697551 | 0.988302449 | 1 | 0.023508505 | 0.976491495 | 1 |
| 530 | 0.011697551 | 0.988302449 | 1 | 0.030777172 | 0.969222828 | 1 |
| 540 | 0.011697551 | 0.988302449 | 1 | 0.042465309 | 0.957534691 | 1 |
| 550 | 0.011697551 | 0.988302449 | 1 | 0.053132848 | 0.946867152 | 1 |
| 560 | 0.011697551 | 0.988302449 | 1 | 0.059973626 | 0.940026374 | 1 |
| 570 | 0.011697551 | 0.988302449 | 1 | 0.062110014 | 0.937889986 | 1 |
| 580 | 0.011697551 | 0.988302449 | 1 | 0.060129145 | 0.939870855 | 1 |
| 590 | 0.011697551 | 0.988302449 | 1 | 0.055745248 | 0.944254752 | 1 |
| 600 | 0.011697551 | 0.988302449 | 1 | 0.045387668 | 0.954612332 | 1 |
| 610 | 0.011697551 | 0.988302449 | 1 | 0.032274258 | 0.967725742 | 1 |
| 620 | 0.011697551 | 0.988302449 | 1 | 0.023379378 | 0.976620622 | 1 |
| 630 | 0.011697551 | 0.988302449 | 1 | 0.027419445 | 0.972580555 | 1 |
| 640 | 0.011697551 | 0.988302449 | 1 | 0.154776422 | 0.845223578 | 1 |
| 650 | 0.011697551 | 0.988302449 | 1 | 0.049095437 | 0.950904563 | 1 |
| 660 | 0.011697551 | 0.988302449 | 1 | 0.046499556 | 0.953500444 | 1 |
| 670 | 0.011697551 | 0.988302449 | 1 | 0.049527651 | 0.950472349 | 1 |
| 680 | 0.011697551 | 0.988302449 | 1 | 0.053460815 | 0.946539185 | 1 |
| 690 | 0.011697551 | 0.988302449 | 1 | 0.055734965 | 0.944265035 | 1 |
| 700 | 0.011697551 | 0.988302449 | 1 | 0.05483776 | 0.94516224 | 1 |
| 710 | 0.011697551 | 0.988302449 | 1 | 0.05000615 | 0.94999385 | 1 |
| 720 | 0.011697551 | 0.988302449 | 1 | 0.041622058 | 0.958377942 | 1 |
| 730 | 0.011697551 | 0.988302449 | 1 | 0.031001024 | 0.968998976 | 1 |
| 740 | 0.011697551 | 0.988302449 | 1 | 0.020662858 | 0.979337142 | 1 |
| 750 | 0.011697551 | 0.988302449 | 1 | 0.014074492 | 0.985925508 | 1 |
| 760 | 0.011697551 | 0.988302449 | 1 | 0.012650138 | 0.987349862 | 1 |
| 770 | 0.011697551 | 0.988302449 | 1 | 0.014324552 | 0.985675448 | 1 |
| 780 | 0.011697551 | 0.988302449 | 1 | 0.017398143 | 0.982601857 | 1 |

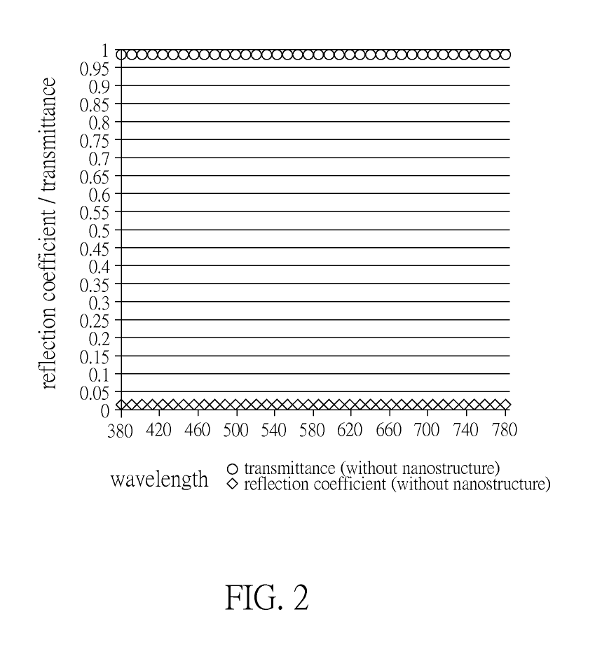

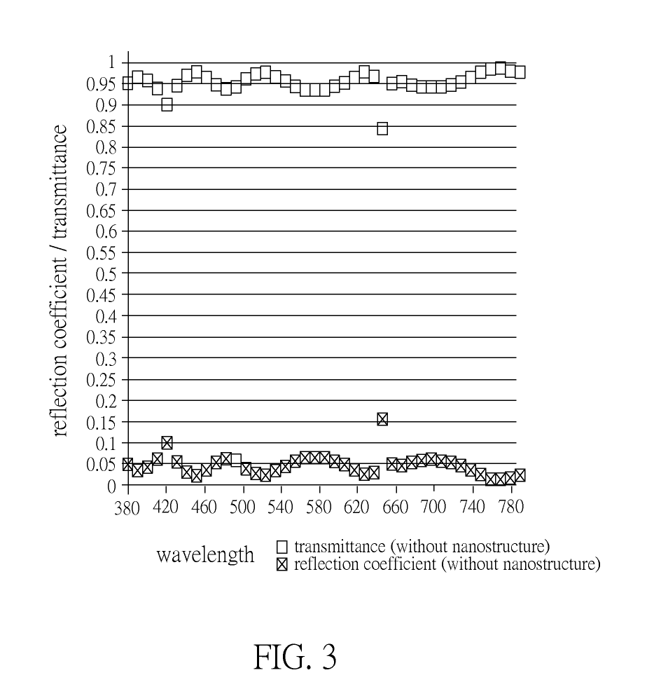

From the above table 1, the composite diffusion film produced by the micro structure 11 and the nanostructure 12, or the diffusion film produced only by the micro structure 11, is respectively analyzed by computer simulation through the rigorous coupled-wave theory and the derived data from relevant conditions is then entered. The data charts shown in FIG. 2 and FIG. 3 are based on the obtained data.

FIG. 2, FIG. 3 and Table 1, shows that significant differences existed in the data of the reflection coefficient and transmittance of the respective diffusion film with or without the nanostructure 12, which are obtained from the rigorous coupled-wave theory proceeding with computer simulation, these various numbers showing that the reflection coefficient and transmittance of the diffusion film with a composite structure of the micro structure 11 and nanostructure 12 would be more constant after each simulation, on the contrary, the reflection coefficient and transmittance of the diffusion film without the nanostructure 12 are more unstable after each simulation. The number fluctuations of the obtained reflection coefficient and transmittance of the diffusion film without the nanostructure 12 are larger than those of the reflection coefficient and transmittance of the diffusion film with a composite structure of the micro structure 11 and nanostructure 12.

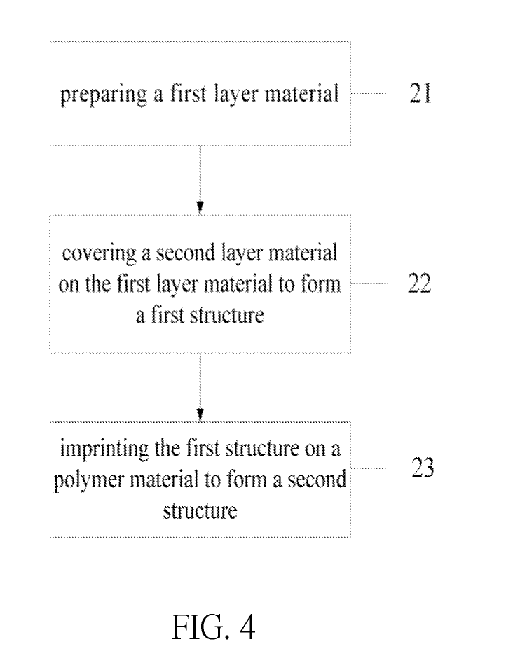

Please refer to FIG. 4, which is a production flow chart showing a micro-nano composite structure of the present invention, comprising the following steps: first of all, preparing a first layer material 21; covering a second layer material on the first layer material to form a first structure 22; imprinting the first structure on a polymer material to form a second structure in a one-time production process 23. In order to avoid nano-holes being blocked in the mold and to get better results, an anti-adhesion process is needed to be executed before step 23. In addition the first layer material is one selected from the group consisting of silicon, germanium, glass and semiconductor materials, an electrolyte of the metal is one selected from the group consisting of oxalic acid, phosphoric acid and sulfuric acid.

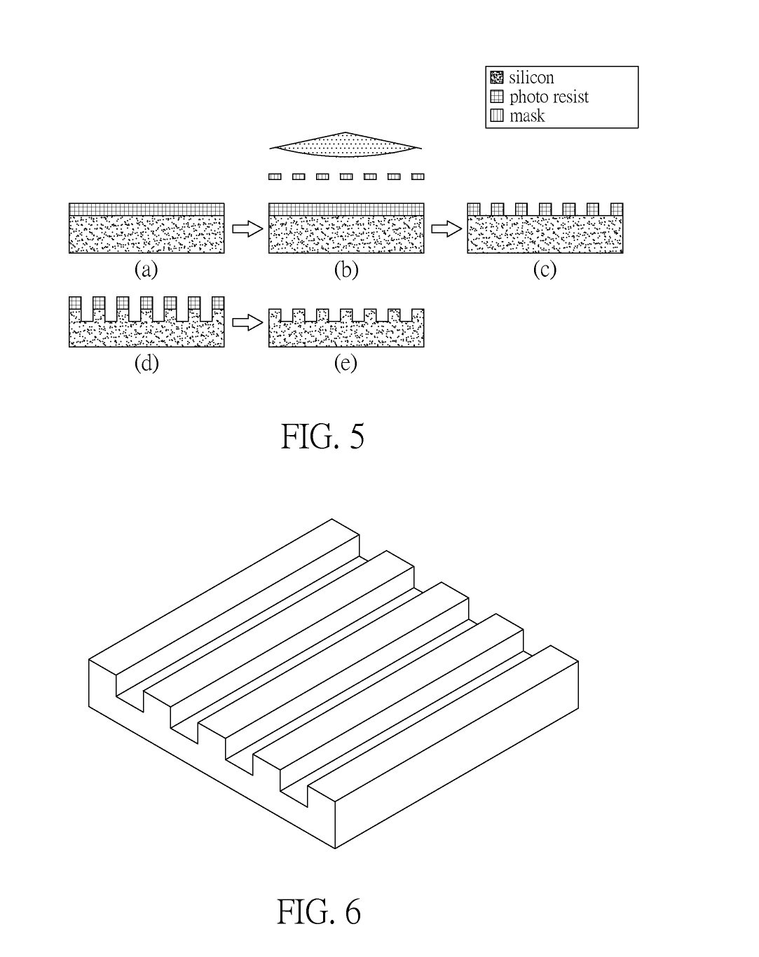

Please refer to FIG. 5, which is the schematic diagram showing the production method of the silicon molds of the present invention, wherein (a) is the spin coating of photoresist on silicon wafer, (b) is the exposure of photoresist by using a chrome mask and ultraviolet, (c) is the development of photoresist, (d) is the dry etching of silicon and (e) is the removal of photoresist. The perspective diagram of the formed silicon mold is as shown in FIG. 6.

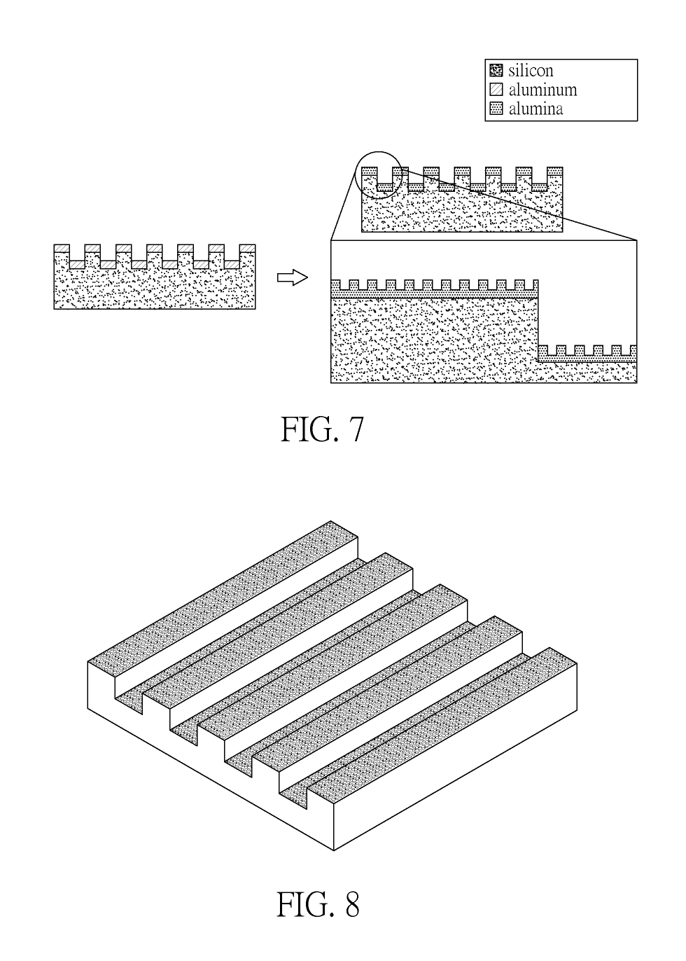

Please refer to FIG. 7, which is the structure diagram showing an anodized aluminum layer formed on a silicon substrate of the present invention, wherein (a) is a micro structure, (b) is a magnified view of the nanostructure. The perspective diagram of the formed micro-nano composite structure is as shown in FIG. 8.

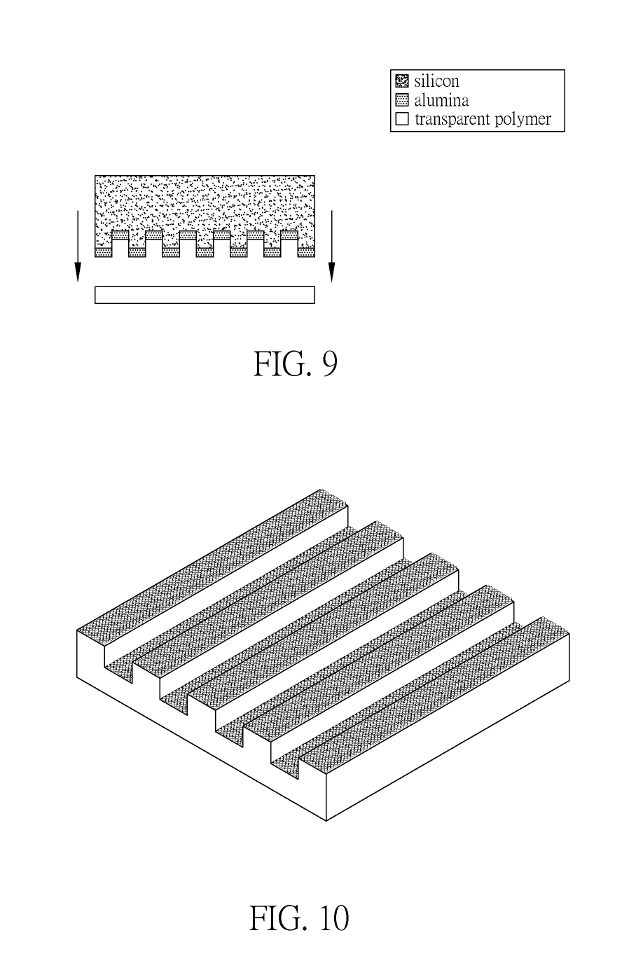

Please refer to FIG. 9, which is a schematic diagram showing that the present invention converts micro-nano structure onto a transparent polymer by using nano-imprint lithography. Upon completion of the nano-imprinting, the perspective diagram showing the polymer structure is shown as FIG. 10, which also has a micro-nano composite structure, which not only can be accomplished in a one-time production process, but also makes mass production possible and reduces the production costs.

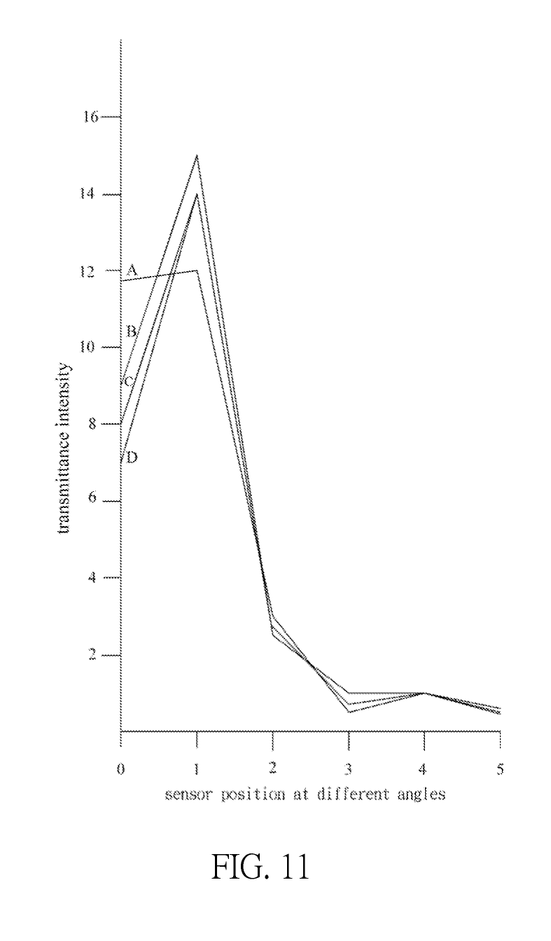

In order to verify the overall light transmission effect of the present invention, different samples with different line widths are respectively used for detecting their respective transmittance at different angles. Since the results are identical, FIG. 11 is taken as an example to show the effect of their transmittance, wherein the vertical axis represents light intensity and the horizontal axis represents the sensor position at different angles (in sequence of 0, 1, 2, 3, 4 and 5),

and curve A denotes the sample without nanostructure, curve B denotes the sample derived from 40 V oxalic acid, curve C denotes the sample derived from 120V phosphoric acid and curve D denotes the sample derived from 120V phosphoric acid.

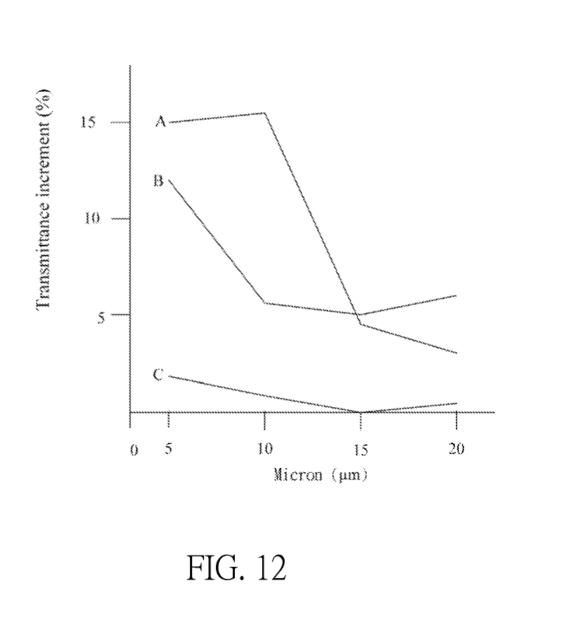

The drawing shows that the transmittance intensity is the maximum when the diffusion film of the micro-nano composite structure is produced by using 40V oxalic acid and the sensor is at position “0”, The transmittance intensity even decreases slightly when the sensor is at position 1. The overall transmission rate is as shown in FIG. 12, which is a diagram of the results showing transmittance increment of each sample of the present invention, wherein the vertical axis is the percentage increasing in light, the horizontal axis is the line width of the micro structure (5, 10, 15 and 20 μm are shown respectively), and curve A denotes the sample derived from 40 V oxalic acid, curve B denotes the sample derived from 120V phosphoric acid and curve C denotes the sample derived from 120V phosphoric acid. The drawing shows that the acquired transmittance intensity is better when the diffusion film of the micro-nano composite structure is produced by using 40V oxalic acid.

Therefore, the micro-nano composite structure provided by the present invention is constructed from the micro structure produced by one first layer material, and then one second layer material (such as aluminum) covers the micro structure, and then a current is passed through the second layer material (such as aluminum) to form the anodized aluminum, and thus producing a nanostructure.

This nanostructure is layered on the micro structure, and the nano imprinting technology is used to form a same micro-nano structure onto a polymer material in a one-time production process and achieve mass production, thus this structure also can achieve a reduction of the reflection coefficients and an increased transmittance, as well as raising the usage rate of the integrated light.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A micro-nano composite structure, comprising:
a micro structure produced by a first layer material; and
a nanostructure produced by a second layer material, and layered on the micro structure to form a micro-nano structure,
wherein, the micro-nano structure can be achieved by imprinting onto a polymer material in a one-time production process.

2. The micro-nano composite structure as recited in claim 1, wherein the first layer material is one selected from the group consisting of silicon, germanium, glass and semiconductor materials.

3. The micro-nano composite structure as recited in claim 1, wherein the nanostructure is a subwavelength structure with anti-reflective properties.

4. The micro-nano composite structure as recited in claim 1, wherein the second layer material is selected from a metal, and a current is passed through the metal for anodizing so as to produce a nanostructure with an anodized metal.

5. The micro-nano composite structure as recited in claim 4, wherein the metal is one selected from the group consisting of aluminum and metal materials; and the nanostructure with an anodized metal is a nanostructure with anodized aluminum.

6. A production method of a micro-nano composite structure, comprising following steps:
(a) preparing a first layer material;
(b) covering a second layer material on the first layer material to form a first structure; and
(c) imprinting the first structure on a polymer material to form a second structure in a one-time production process.

7. The micro-nano composite structure as recited in claim 6, wherein the first layer material is one selected from the group consisting of silicon, germanium, glass and semiconductor materials.

8. The micro-nano composite structure as recited in claim 6, wherein the second layer material is selected from a metal, and a current is passed through the metal for anodizing so as to produce a nanostructure with anodized metal.

9. The micro-nano composite structure as recited in claim 6, wherein the metal is one selected from the group consisting of aluminum and metal materials.

10. The micro-nano composite structure as recited in claim 6, wherein an electrolyte of the metal is one selected from the group consisting of oxalic acid, phosphoric acid and sulfuric acid.

11. The micro-nano composite structure as recited in claim 6, wherein an anti-adhesion process is needed before step (c).

12. The micro-nano composite structure as recited in claim 6, wherein both the first structure and the second structure are a micro-nano composite structure.
